(19) United States
(12) Patent Application Publication
(10) Pub. No.: US 2017/0068912 A1
(43) Pub. Date: Mar. 9, 2017

(54) ALLOCATING COSTS OF SHARED RESOURCES

(71) Applicant: HEWLETT PACKARD ENTERPRISE DEVELOPMENT LP, Houston, TX (US)

(72) Inventors: Rotem Steuer, Yehud (IL); Sigalit Sade, Yehud (IL); Michael Gopshtein, Yehud (IL)

(21) Appl. No.: 15/121,829

(22) PCT Filed: Feb. 28, 2014
(86) PCT No.: PCT/US2014/019262

§ 371 Date: Aug. 26, 2016

(51) Int. Cl. G06Q 10/06; H04L 12/26

(52) U.S. Cl. CPC G06Q 10/0631; H04L 43/0876

(57) ABSTRACT

Example implementations relate to allocating costs of a shared resource. In example implementations, an aspect of a shared resource may be defined. A distribution, between a plurality of users, may be determined for the defined aspect. The distribution may be based on usage of the shared resource by the plurality of users. A representation associated with a respective user in the plurality of users may be generated based on usage of the shared resource.

### BACKGROUND

Devices and services may be used by multiple entities. Costs associated with such devices and services may be split between the entities that use them. Entities may be charged on a per-use basis or may be charged a recurring flat fee (e.g., monthly or yearly rate).

### BRIEF DESCRIPTION OF THE DRAWINGS

The following detailed description references the drawings, wherein:

FIG. 1 is a block diagram of an example device that includes a machine-readable storage medium encoded with instructions to enable cost allocation for a shared resource;

FIG. 2 is a block diagram of an example device that includes a machine-readable storage medium encoded with instructions to quantify communications associated with users of a shared resource;

FIG. 3 is a block diagram of an example device that includes a machine-readable storage medium encoded with instructions to generate an aggregate representation of portions of a usage distribution;

FIG. 4 is a block diagram of an example device that includes a machine-readable storage medium encoded with instructions to generate a representation of a user's usage of a shared resource;

FIG. 5 is a block diagram of an example device that includes a machine-readable storage medium encoded with instructions to generate an aggregate representation of usage of a shared resource;

FIG. 6 is a flowchart of an example method for allocating cost of a shared resource;

FIG. 7 is a flowchart of an example method for analyzing communications to and from a shared resource; and

FIG. 8 is a flowchart of an example method for generating representations of usage of a shared resource.

### DETAILED DESCRIPTION

As mentioned above, costs associated with devices and services may be split between the entities that use them. Costs may be calculated by human consultants using usage logs and/or metrics. However, usage logs may not be detailed enough to accurately determine how much of a resource various entities are using, and maintaining extremely detailed usage logs may negatively affect device/service performance. Also, human consultants may not have tools to manage and analyze high volumes of usage and data. Charging entities automatically on a per-use or recurring basis may not fairly distribute costs, as processing power may vary from request to request, and usage patterns may change over time.

In light of the above, the present disclosure provides for cost allocation based on actual usage by various entities. The present disclosure enables automatic and accurate calculation of usage distributions that may be constantly adjusted even when usage volume is high, without keeping or collecting information from usage logs. In addition, the present disclosure enables usage by various entities to be tracked over time so that the impact of each entity over time may be accurately determined and the entities may be charged accordingly, allowing visibility into the cost allocation process.

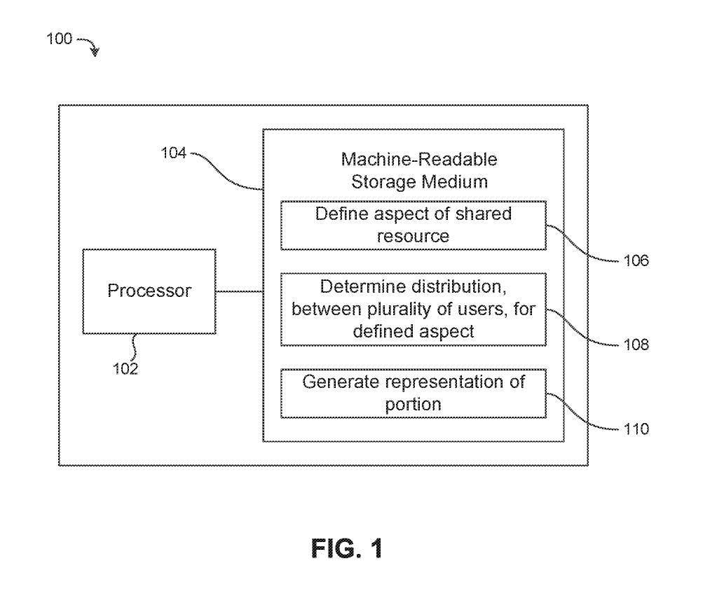

Referring now to the drawings, FIG. 1 is a block diagram of an example device 100 that includes a machine-readable storage medium encoded with instructions to enable cost allocation for a shared resource. As used herein, the terms “Include”, “have”, and “comprise” are interchangeable and should be understood to have the same meaning. Device 100 may operate as and/or be part of a server. In FIG. 1, device 100 includes processor 102 and machine-readable storage medium 104.

Processor 102 may include a central processing unit (CPU), microprocessor (e.g., semiconductor-based microprocessor), and/or other hardware device suitable for retrieval and/or execution of instructions stored in machine-readable storage medium 104. Processor 102 may fetch, decode, and/or execute instructions 106, 108, and 110 to enable cost allocation for a shared resource, as described below. As an alternative or in addition to retrieving and/or executing instructions, processor 102 may include an electronic circuit comprising a number of electronic components for performing the functionality of instructions 106, 108, and/or 110.

Machine-readable storage medium 104 may be any suitable electronic, magnetic, optical, or other physical storage device that contains or stores executable instructions. Thus, machine-readable storage medium 104 may include, for example, a random-access memory (RAM), an Electrically Erasable Programmable Read-Only Memory (EEPROM), a storage device, an optical disc. and the like. In some implementations, machine-readable storage medium 104 may include a non-transitory storage medium, where the term “non-transitory” does not encompass transitory propagating signals. As described in detail below, machine-readable storage medium 104 may be encoded with a set of executable instructions 106, 108, and 110.

Instructions 106 may define an aspect of a shared resource. As used herein, the term “shared resource”' should be understood to refer to a resource that is used by multiple users. Examples of shared resources may include servers, shared storage networks, and cloud services. As used herein, the term “users” may refer to human people, business units, applications, cost centers, divisions, departments, projects, or any other suitable entities that may be billed for costs associated with a shared resource. As used herein, the term “aspect”, as used with respect to a shared resource, should be understood to refer to a component of or service provided by the shared resource, or a quantity or measurement associated with such a component or service, or any suitable combination thereof. Aspects of a shared resource may include, for example, hardware or network devices of the shared resources, licenses used by the shared resource, a time period over which the shared resource is used, storage space used by the shared resource, and/or monetary costs associated with any of the above and/or other aspects of the shared resource. An aspect of a shared resource may be defined so that a cost associated with the aspect may be determined and allocated among users of the shared resource.

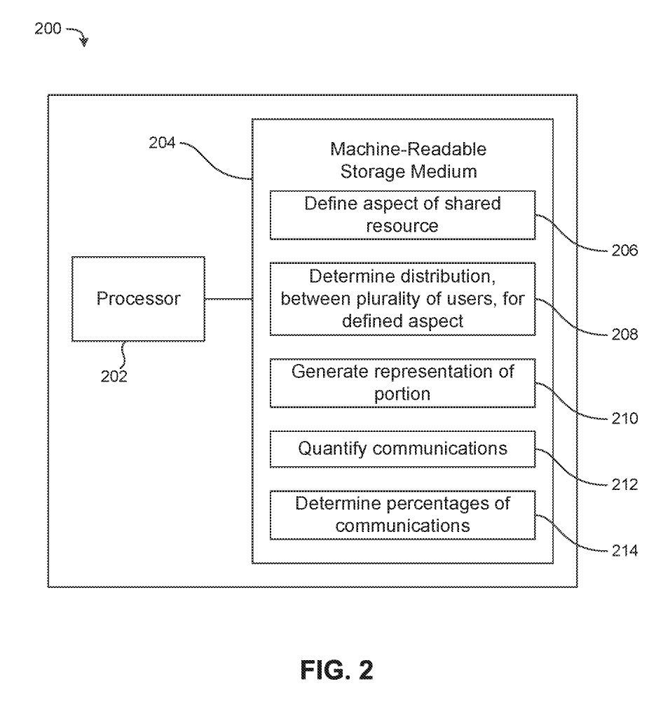

Instructions 108 may determine a distribution, between a plurality of users, for the defined aspect. The distribution may be based on usage of the shared resource by the plurality of users. Usage of the shared resource may include sending requests to and receiving responses from the shared resource, as discussed further with respect to FIG. 2. The distribution may include a plurality of portions associated with respective users in the plurality of users. The portions may collectively represent the aspect in totality. For example, an aspect may be defined as memory used by a shared resource over a period of time, and a portion may represent how much memory in the shared resource a respective user uses over the period of time. All portions together may represent the total amount of memory used by users of the shared resource over the period of time.

Instructions 110 may generate a representation of a portion, in the plurality of portions, associated with a respective user in the plurality of users. The representation of the portion may be in context of the aspect in totality. For example, the representation of the portion may indicate how much memory in the shared resource the respective user has used during a period of time, and may indicate the total amount of memory used by all users of the shared resource over the period of time. In some implementations, the representation of the portion may include a graphical illustration (e.g., pie chart, vertical bar, horizontal bar) that indicates what percentage of the total amount of memory was used by the respective user.

FIG. 2 is a block diagram of an example device 200 that includes a machine-readable storage medium encoded with instructions to quantify communications associated with users of a shared resource. Device 200 may operate as and/or be part of a server. In FIG. 2, device 200 includes processor 202 and machine-readable storage medium 204.

As with processor 102 of FIG. 1, processor 202 may include a CPU, microprocessor (e.g., semiconductor-based microprocessor), and/or other hardware device suitable for retrieval and/or execution of instructions stored in machine-readable storage medium 204. Processor 202 may fetch, decode, and/or execute instructions 206, 208, 210, 212, and 214. As an alternative or in addition to retrieving and/or executing instructions, processor 202 may include an electronic circuit comprising a number of electronic components for performing the functionality of instructions 206, 208, 210, 212, and/or 214.

As with machine-readable storage medium 104 of FIG. 1, machine-readable storage medium 204 may be any suitable physical storage device that stores executable instructions. Instructions 206, 208, and 210 on machine-readable storage medium 204 may be analogous to (e.g., have functions and/or components similar to) instructions 106, 108, and 110 on machine-readable storage medium 104. Instructions 212 may quantify communications associated with each of a plurality of users of a shared resource. Communications to and from the shared resource may be monitored. Communications may include requests and responses. For example, requests may include queries of databases of the shared resource and/or commands to perform certain actions, and responses may include transfers of data responsive to such queries and/or confirmations of performance of commanded actions.

In some implementations, communications may be monitored using real user monitoring (RUM) technology. In some implementations, RUM technology may be used to sniff traffic directly from network switches of the shared resource or via traffic duplication (e.g., Generic Routing Encapsulation [GRE] tunneling). In some implementations, RUM technology may be used to monitor communications from the shared resource side, for example using a monitoring/diagnostic agent installed on the shared resource. In some implementations, RUM technology may be used to monitor communications from the user side, for example by running scripts on users' machines.

Each of the communications (e.g., each request and each response) may be associated with one of the plurality of users. In some implementations, RUM technology may be used to determine which communications are associated with which user. In some implementations, RUM technology may analyze IP addresses to determine which respective users submitted various requests, and to which respective users various responses were directed. In some implementations, RUM technology may match communications to users based on login information/credentials, user accounts, and/or session properties. Any other suitable techniques for identifying users associated with communications may be used.

After communications have been associated with their respective users, RUM technology and/or other suitable technology may be used to quantify how many communications are associated with each user. In some implementations, the RUM technology used to monitor, associate, and/or quantify communications may be implemented on the same machine. In some implementations, the RUM technology used to monitor, associate, and/or quantify communications may be implemented on (e.g., distributed across) multiple machines.

A distribution between the plurality of users for a defined aspect of the shared resource may be determined based on the quantified communications. The distribution may include a plurality of portions associated with respective users in the plurality of users. For example, the plurality of portions may include a first portion associated with a first user in the plurality of users, and a second portion associated with a second user in the plurality of users. The first portion may represent how many communications are associated with the first user, and the second portion may represent how many communications are associated with the second user. Collectively, the plurality of portions may represent the total number of communications between the shared resource and the plurality of users.

Instructions 214 may determine, based on the quantified communications, percentages of communications associated with respective users. For example, instructions 214 may determine a first percentage of communications associated with the first user, and a second percentage of communications associated with the second user. A size of the first portion may be proportional to the first percentage, and a size of the second portion may be proportional to the second percentage. The relative sizes of the portions may be used to allocate a total cost (e.g., maintenance cost, hardware replacement cost, and/or license fee) associated with the shared resource. For example, the first user may be charged a percentage, of the total cost, that is equal to the first percentage. The second user may be charged a percentage, of the total cost, that is equal to the second percentage. The monetary cost, the amount charged to the first user, and a representation of the first portion may be displayed in a bill sent to the first user. The monetary cost, the amount charged to the second user, and a representation of the second portion may be displayed in a bill sent to the second user.

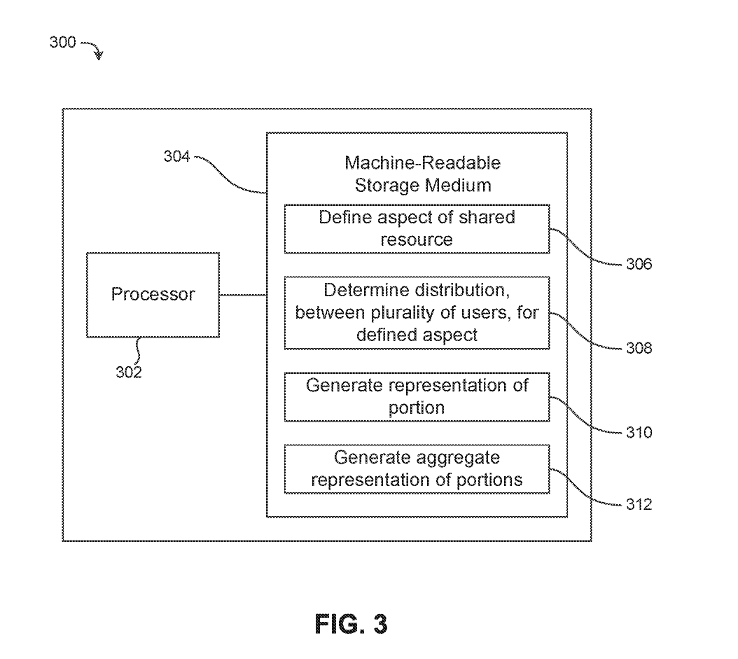

FIG. 3 is a block diagram of an example device 300 that includes a machine-readable storage medium encoded with instructions to generate an aggregate representation of portions of a usage distribution. Device 300 may operate as and/or be part of a server. In FIG. 3, device 300 includes processor 302 and machine-readable storage medium 304.

As with processor 102 of FIG. 1 processor 302 may include a CPU, microprocessor (e.g., semiconductor-based microprocessor), and/or other hardware device suitable for retrieval and/or execution of instructions stored in machine-readable storage medium 304. Processor 302 may fetch, decode, and/or execute instructions 306, 308, 310, and 312. As an alternative or in addition to retrieving and/or executing instructions, processor 302 may include an electronic circuit comprising a number of electronic components for performing the functionality of instructions 306, 308, 310, and/or 312.

As with machine-readable storage medium 104 of FIG. 1, machine-readable storage medium 304 may be any suitable physical storage device that stores executable instructions. Instructions 306, 308, and 310 on machine-readable storage medium 304 may be analogous to instructions 106, 108, and 110 on machine-readable storage medium 104. Instructions 308 may determine a distribution, between a plurality of users, for a defined aspect of a shared resource. The distribution may include a plurality of portions associated with respective users in the plurality of users. Instructions 310 may generate a representation of a portion, in the plurality of portions, associated with a respective user in the plurality of users. The portion of which the representation is generated may be a first portion associated with a first user in the plurality of users.

Instructions 312 may generate an aggregate representation of portions, in the plurality of portions, other than the first portion. Relative sizes of the first portion representation and the aggregate representation may be based on usage of the shared resource by the first user relative to aggregate use of the shared resource by other users in the plurality of users. Usage of the shared resource by various users may be determined by determining which users are associated with which communications to and from the shared resource, and quantifying such communications, as discussed above with respect to FIG. 2. In some implementations, the first portion representation may indicate what percentage of communications are associated with the first user, and the aggregate representation of portions may indicate what percentage of communications are associated with users other than the first user in the plurality of users. For example, the first portion representation and the aggregate representation may be displayed as a pie chart having two “slices”, once slice being the first portion representation and the other slice being the aggregate representation. The percentages, of the pie chart, occupied by the first portion representation slice and the aggregate representation slice may correspond to the respective percentage of communications associated with the first user and other users, respectively. It should be understood that the first portion representation and aggregate representation may be displayed in other ways, such as other suitable graphical representations and/or numerical representations.

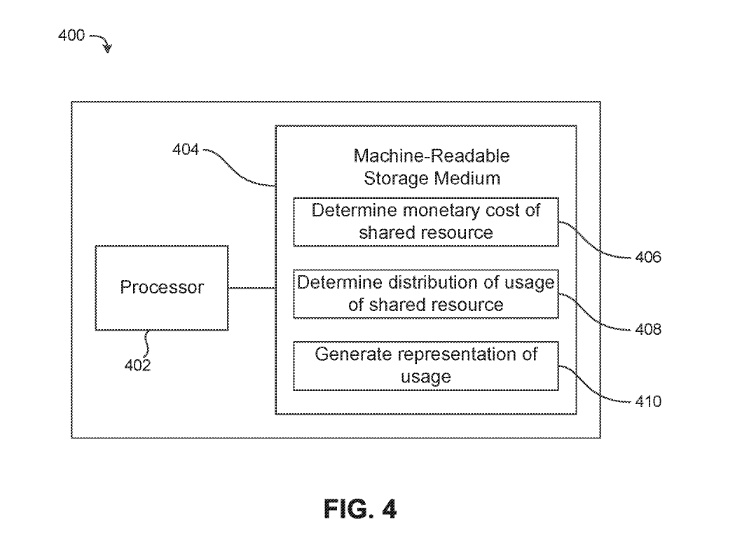

FIG. 4 is a block diagram of an example device 400 that includes a machine-readable storage medium encoded with instructions to generate a representation of a user's usage of a shared resource. Device 400 may operate as and/or be part of a server. In FIG. 4, device 400 includes processor 402 and machine-readable storage medium 404.

As with processor 102 of FIG. 1, processor 402 may include a CPU, microprocessor (e.g., semiconductor-based microprocessor), and/or other hardware device suitable for retrieval and/or execution of instructions stored in machine-readable storage medium 404. Processor 402 may fetch, decode, and/or execute instructions 406, 408, and 410. As an alternative or in addition to retrieving and/or executing instructions, processor 402 may include an electronic circuit comprising a number of electronic components for performing the functionality of instructions 406, 408, and/or 410.

As with machine-readable storage medium 104 of FIG. 1, machine-readable storage medium 404 may be any suitable physical storage device that stores executable instructions. In some implementations, machine-readable storage medium 404 may include a non-transitory storage medium. As described in detail below, machine-readable storage medium 404 may be encoded with a set of executable instructions 406, 408, and 410.

Instructions 406 may determine a monetary cost, for a period of time, of a shared resource. The monetary cost may be a cost of providing the shared resource to a plurality of users. For example, the monetary cost may be the cost of maintaining a server of the shared resource during the period of time (e.g., one month), or the cost of licenses for one year.

Instructions 408 may determine a distribution, between a plurality of users, of usage of the shared resource during the period of time. The plurality of users may be associated with communications to and from the shared resource during the period of time. The distribution may indicate what percentage of total communications during the period of time each of the plurality of users is responsible for. In some implementations, the distribution may be determined based on data collected using RUM technology. For example, RUM technology may be used to monitor communications to and from the shared resource during the period of time, determine which communications are associated with which of the plurality of users, and quantify the number of communications associated with each user, as discussed above with respect to FIG. 2.

Instructions 410 may generate a representation of usage, of the shared resource, by one of the plurality of users during the period of time. The generated representation may indicate usage by the one of the plurality of users compared to total usage by the plurality of users during the period of time. For example, the generated representation may indicate what percentage of total communications during the period of time are associated with the one of the plurality of users. In some implementations, the generated representation may include a graphical illustration (e.g., pie chart, vertical bar, horizontal bar) that indicates what percentage of total communications during the period of time are associated with the one of the plurality of users. The one of the plurality of users may be charged a percentage, of the monetary cost, that is equal to the percentage indicated in the graphical illustration. The monetary cost, the amount charged to the one of the plurality of users, and the representation of the user's usage may be displayed in a bill sent to the user.

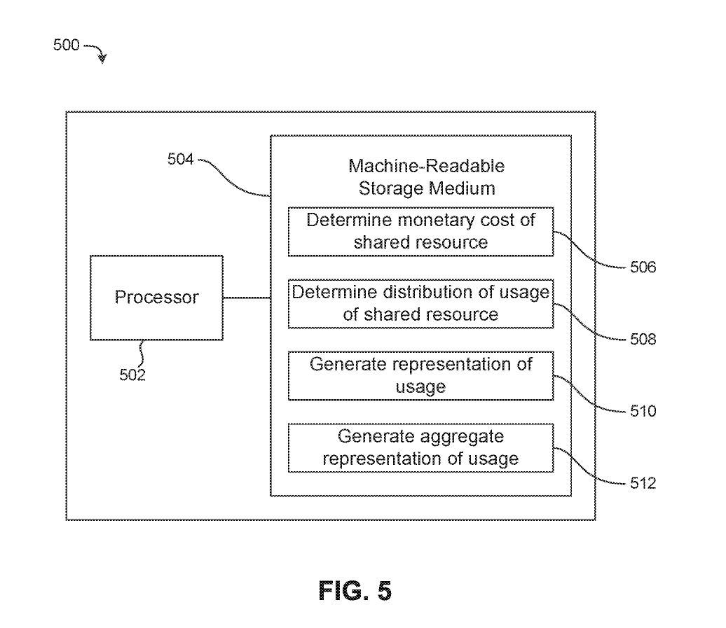

FIG. 5 is a block diagram of an example device 500 that includes a machine-readable storage medium encoded with instructions to generate an aggregate representation of usage of a shared resource. Device 500 may operate as and/or be part of a server. In FIG. 5, device 500 includes processor 502 and machine-readable storage medium 504.

As with processor 402 of FIG. 4, processor 502 may include a CPU, microprocessor (e.g., semiconductor-based microprocessor), and/or other hardware device suitable for retrieval and/or execution of instructions stored in machine-readable storage medium 504. Processor 502 may fetch, decode, and/or execute instructions 506, 508, 510, and 512. As an alternative or in addition to retrieving and/or executing instructions, processor 502 may include an electronic circuit comprising a number of electronic components for performing the functionality of instructions 506, 508, 510, and/or 512.

As with machine-readable storage medium 404 of FIG. 4, machine-readable storage medium 504 may be any suitable physical storage device that stores executable instructions. Instructions 506, 508, and 510 on machine-readable storage medium 504 may be analogous to instructions 406, 408, and 410 on machine-readable storage medium 404. Instructions 510 may generate a representation of usage, of a shared resource, by a first user of a plurality of users during a period of time. Instructions 512 may generate an aggregate representation of usage, of the shared resource, by users other than the first user in the plurality of users during the period of time. Relative sizes of the first user representation and the aggregate representation may be based on usage of the shared resource by the first user relative to aggregate use of the shared resource by other users in the plurality of users during the period of time. Usage of the shared resource by various users may be determined by determining which users are associated with which communications to and from the shared resource, and quantifying such communications, as discussed above with respect to FIG. 2.

In some implementations, the first user representation may indicate what percentage of communications are associated with the first user, and the aggregate representation may indicate what percentage of communications are associated with users other than the first user in the plurality of users. For example, the first user representation and the aggregate representation may be displayed as a pie chart having two “slices”, once slice being the first user representation and the other slice being the aggregate representation. The percentages, of the pie chart, occupied by the first user representation slice and the aggregate representation slice may correspond to the respective percentage of communications associated with the first user and other users, respectively. It should be understood that the first user representation and aggregate representation may be displayed in other ways, such as other suitable graphical representations and/or numerical representations. The first user may be charged a percentage, of a monetary cost associated with the shared resource, that is equal to the percentage indicated by the first user representation. The monetary cost, the amount charged to the first user, and the first user and aggregate representations may be displayed in a bill sent to the first user.

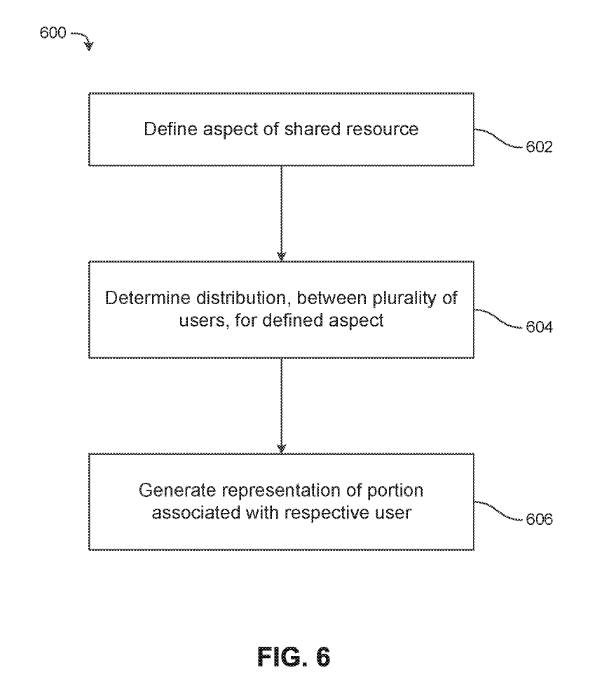

Methods related to cost allocation for shared resources are discussed with respect to FIGS. 6-8. FIG. 6 is a flowchart of an example method 600 for allocating cost of a shared resource. Although execution of method 600 is described below with reference to processor 102 of FIG. 1, it should be understood that execution of method 600 may be performed by other suitable devices, such as processors 202 and 302 of FIGS. 2 and 3, respectively. Method 600 may be implemented in the form of executable instructions stored on a machine-readable storage medium and/or in the form of electronic circuitry.

Method 600 may start in block 602, where processor 102 may define an aspect of a shared resource. In some implementations, defining an aspect of the shared resource may include defining a time period over which the shared resource was used by a plurality of users. In some implementations, the defined aspect may include a monetary cost.

Next, in block 604, processor 102 may determine a distribution, between a plurality of users, for the defined aspect of block 602. The distribution may be based on usage of the shared resource by the plurality of users. Usage of the shared resource may include sending requests to and receiving responses from the shared resource, as discussed above with respect to FIG. 2. The distribution may include a plurality of portions associated with respective users in the plurality of users. The portions may collectively represent the aspect in totality. In some implementations, the aspect may be a monetary cost, each of the plurality of portions may represent an amount charged to a respective user, and the portions may collectively represent the total monetary cost.

Finally, in block 606, processor 102 may generate a representation of a portion, in the plurality of portions, associated with a respective user in the plurality of users. The representation of the portion may be in context of the aspect in totality. For example, the representation of the portion may indicate how much memory in the shared resource the respective user has used during a period of time, and may indicate the total amount of memory used by all users of the shared resource over the period of time. In some implementations, the representation of the portion may include a graphical illustration (e.g., pie chart, vertical bar, horizontal bar) that indicates what percentage of the total amount of memory was used by the respective user.

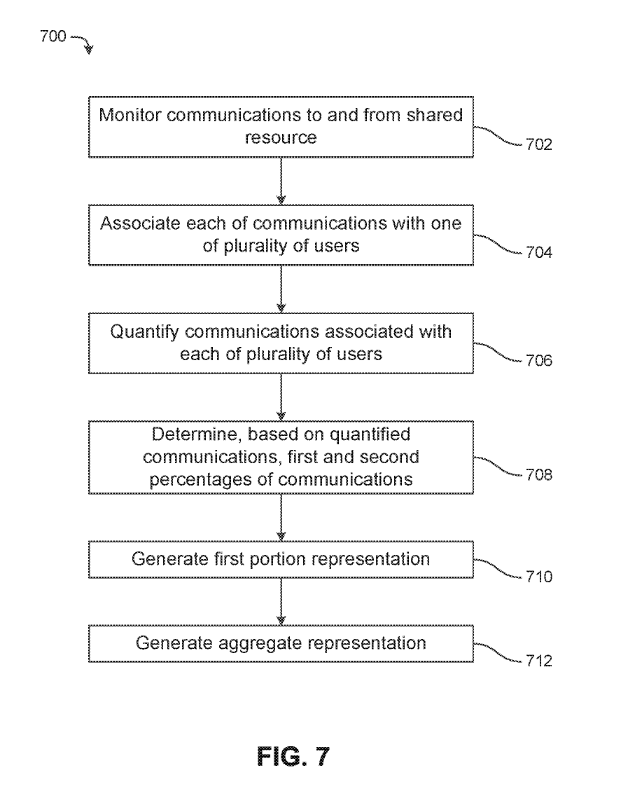

FIG. 7 is a flowchart of an example method 700 for analyzing communications to and from a shared resource. Although execution of method 700 is described below with reference to processor 302 of FIG. 3, it should be understood that execution of method 700 may be performed by other suitable devices, such as processors 102 and 202 of FIGS. 1 and 2, respectively. Some blocks of method 700 may be performed in parallel with and/or after method 600. Method 700 may be implemented in the form of executable instructions stored on a machine-readable storage medium and/or in the form of electronic circuitry.

Method 700 may start in block 702, where processor 302 may monitor communications to and from a shared resource. Communications may include requests and responses. In some implementations, monitoring communications may be performed using RUM technology. In some implementations, RUM technology may be used to sniff traffic directly from network switches of the shared resource or via traffic duplication (e.g., GRE tunneling). In some implementations, RUM technology may be used to monitor communications from the shared resource side, for example using a monitoring/diagnostic agent installed on the shared resource. In some implementations, RUM technology may be used to monitor communications from the user side, for example by running scripts on users' machines.

In block 704, processor 302 may associate each of the communications with one of a plurality of users of the shared resource. In some implementations, RUM technology may be used to determine which communications are associated with which user. In some implementations, RUM technology may analyze IP addresses to determine which respective users submitted various requests, and to which respective users various responses were directed. In some implementations, RUM technology may match communications to users based on login information/credentials, user accounts, and/or session properties. Any other suitable techniques for identifying users associated with communications may be used.

In block 706, processor 302 may quantify communications associated with each of the plurality of users. A distribution, between the plurality of users, for a defined aspect of the shared resource may be determined based on the quantified communications. The distribution may include a plurality of portions associated with respective users in the plurality of users, and the portions may collectively represent the aspect in totality. The plurality of portions may include a first portion associated with a first user in the plurality of users, and a second portion associated with a second user in the plurality of users. In some implementations, the RUM technology used to monitor, associate, and/or quantify communications may be implemented on the same machine. In some implementations, the RUM technology used to monitor, associate, and/or quantify communications may be implemented on (e.g., distributed across) multiple machines. It should be understood that elements of blocks 702, 704, and 706 may be performed in parallel.

Next, in block 708, processor 302 may determine, based on the quantified communications, a first percentage of communications associated with the first user, and a second percentage of communications associated with the second user. A size of the first portion may be proportional to the first percentage, and a size of the second portion may be proportional to the second percentage. The relative sizes of the portions may be used to allocate a total cost (e.g., maintenance cost, hardware replacement cost, and/or license fee) associated with the shared resource. For example, the first user may be charged a percentage, of the total cost, that is equal to the first percentage. The second user may be charged a percentage, of the total cost, that is equal to the second percentage.

In block 710, processor 302 may generate a representation of the first portion. The first portion representation may be in context of the defined aspect in totality. For example, the first portion representation may indicate what percentage of communications to and from the shared resource are associated with the first user. In some implementations, the first portion representation may include a graphical illustration (e.g., pie chart, vertical bar, horizontal bar). In some implementations, processor 302 may also generate a representation of the second portion in a manner similar to that used to generate the representation of the first portion.

Finally, in block 712, processor 302 may generate an aggregate representation of portions, in the plurality of portions, other than the first portion. Relative sizes of the first portion representation and the aggregate representation may be based on usage of the shared resource by the first user relative to aggregate use of the shared resource by other users in the plurality of users. In some implementations, the first portion representation may indicate what percentage of communications are associated with the first user, and the aggregate representation of portions may indicate what percentage of communications are associated with users other than the first user in the plurality of users, as discussed above with respect to FIG. 3. A total cost associated with the shared resource, an amount charged to the first user (e.g., a percentage of the total cost equal to the percentage of communications associated with the first user), and the first portion and aggregate representations may be displayed in a bill sent to the first user. A total cost associated with the shared resource, an amount charged to the second user (e.g., a percentage of the total cost equal to the percentage of communications associated with the second user), and the second portion and aggregate representations may be displayed in a bill sent to the second user.

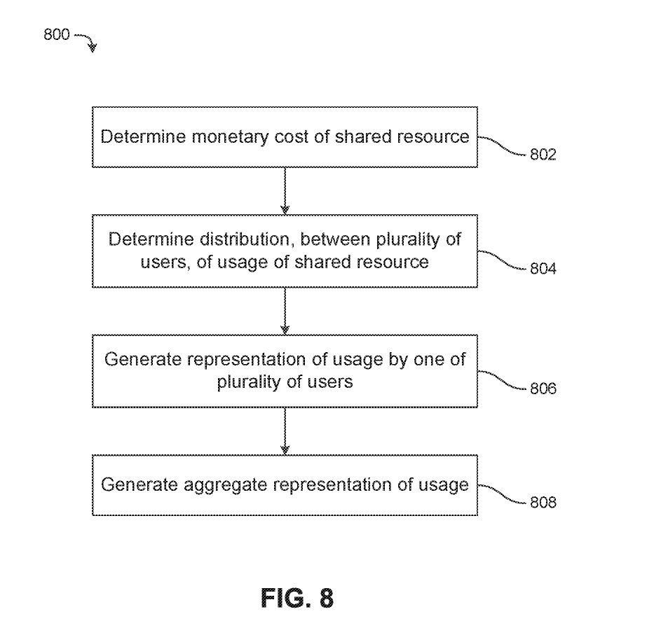

FIG. 8 is a flowchart of an example method 800 for generating representations of usage of a shared resource. Although execution of method 800 is described below with reference to processor 502 of FIG. 5, it should be understood that execution of method 800 may be performed by other suitable devices, such as processor 402 of FIG. 4. Method 800 may be implemented in the form of executable instructions stored on a machine-readable storage medium and/or in the form of electronic circuitry.

Method 800 may start in block 802, where processor 502 may determine a monetary cost, for a period of time, of a shared resource. The monetary cost may be a cost of providing the shared resource to a plurality of users. For example, the monetary cost may be the cost of maintaining a server of the shared resource during the period of time (e.g., one month), or the cost of licenses for one year.

In block 804, processor 502 may determine a distribution, between a plurality of users, of usage of the shared resource during the period of time. The plurality of users may be associated with communications to and from the shared resource during the period of time. The distribution may indicate what percentage of total communications during the period of time each of the plurality of users is responsible for. In some implementations, the distribution may be determined based on data collected using RUM technology. For example, RUM technology may be used to monitor communications to and from the shared resource during the period of time, determine which communications are associated with which of the plurality of users, and quantify the number of communications associated with each user, as discussed above with respect to FIG. 2.

Next, in block 806, processor 502 may generate a representation of usage, of the shared resource, by one of the plurality of users during the period of time. The generated representation may indicate usage by the one of the plurality of users compared to total usage by the plurality of users during the period of time. For example, the generated representation may indicate usage by a first user in the plurality of users compared to total usage by users other than the first user in the plurality of users during the period of time. In some implementations, the generated representation may include a graphical illustration (e.g., pie chart, vertical bar, horizontal bar) that indicates what percentage of total communications during the period of time are associated with the first user. The first user may be charged a percentage, of the monetary cost, that is equal to the percentage indicated in the graphical illustration.

Finally, in block 808, processor 502 may generate an aggregate representation of usage, of the shared resource, by users other than the first user in the plurality of users during the period of time. Relative sizes of the first user representation and the aggregate representation may be based on usage of the shared resource by the first user relative to aggregate use of the shared resource by other users in the plurality of users during the period of time. In some implementations, the aggregate representation may indicate what percentage of communications are associated with users other than the first user in the plurality of users. For example, the first user representation and the aggregate representation may be displayed as a pie chart having two “slices”, once slice being the first user representation and the other slice being the aggregate representation, as discussed above with respect to FIG. 5. In some implementations, the aggregate representation may be displayed in a bill sent to the first user.

The foregoing disclosure describes allocating costs of shared resources. Example implementations described herein enable usage distributions to be accurately calculated for multiple users of a shared resource and allow visibility into the cost allocation process.

We claim:

1. A method for allocating cost of a shared resource, the method comprising:
defining an aspect of the shared resource;
determining a distribution, between a plurality of users, for the defined aspect, wherein:
the distribution is based on usage of the shared resource by the plurality of users;
the distribution comprises a plurality of portions associated with respective users in the plurality of users; and
the portions collectively represent the aspect in totality; and
generating a representation of a portion, in the plurality of portions, associated with a respective user in the plurality of users, wherein the representation of the portion is in context of the aspect in totality.

2. The method of claim 1, further comprising:
monitoring communications to and from the shared resource, wherein communications comprise requests and responses, and wherein usage of the shared resource comprises sending requests to and receiving responses from the shared resource;
associating each of the communications with one of the plurality of users; and
quantifying communications associated with each of the plurality of users, wherein the distribution is determined based on the quantified communications.

3. The method of claim 2, wherein monitoring communications is performed using real user monitoring (RUM) technology.

4. The method of claim 2, wherein:
determining a distribution comprises determining, based on the quantified communications, a first percentage of communications associated with a first user in the plurality of users, and a second percentage of communications associated with a second user in the plurality of users;
the plurality of portions comprises a first portion associated with the first user, and a second portion associated with the second user;
a size of the first portion is proportional to the first percentage; and
a size of the second portion is proportional to the second percentage.

5. The method of claim 1, wherein defining an aspect of the shared resource comprises defining a time period over which the shared resource was used by the plurality of users.

6. The method of claim 1, wherein the portion of which the representation is generated is a first portion associated with a first user in the plurality of users, the method further comprising generating an aggregate representation of portions, in the plurality of portions, other than the first portion, wherein relative sizes of the first portion representation and the aggregate representation are based on usage of the shared resource by the first user relative to aggregate use of the shared resource by other users in the plurality of users.

7. The method of claim 1, wherein the defined aspect is a monetary cost, and wherein each of the plurality of portions represents an amount charged to a respective user.

8. A machine-readable storage medium encoded with instructions executable by a processor for allocating cost of a shared resource, the machine-readable storage medium comprising:
instructions to define an aspect of the shared resource;
instructions to determine a distribution, between a plurality of users, for the defined aspect, wherein:
the distribution is based on usage of the shared resource by the plurality of users;
the distribution comprises a plurality of portions associated with respective users in the plurality of users; and
the portions collectively represent the aspect in totality; and
instructions to generate a representation of a portion, in the plurality of portions, associated with a respective user in the plurality of users, wherein the representation of the portion is in context of the aspect in totality.

9. The machine-readable storage medium of claim 8, further comprising instructions to quantify communications associated with each of the plurality of users, wherein:
communications to and from the shared resource are monitored;
communications comprise requests and responses;
usage of the shared resource comprises sending requests to and receiving responses from the shared resource;
each of the communications is associated with one of the plurality f users; and
the distribution is determined based on the quantified communications.

10. The machine-readable storage medium of claim 9, wherein communications are monitored using real user monitoring (RUM) technology.

11. The machine-readable storage medium of claim 9, further comprising instructions to determine, based on the quantified communications, a first percentage of communications associated with a first user in the plurality of users, and a second percentage of communications associated with a second user in the plurality of users, wherein:
the plurality of portions comprises a first portion associated with the first user, and a second portion associated with the second user;
a size of the first portion is proportional to the first percentage; and
a size of the second portion is proportional to the second percentage.

12. The machine-readable storage medium of claim 8, wherein the portion of which the representation is generated is a first portion associated with a first user in the plurality of users, the machine-readable storage medium further comprising instructions to generate an aggregate representation of portions, in the plurality of portions, other than the first portion, wherein relative sizes of the first portion representation and the aggregate representation are based on usage of the shared resource by the first user relative to aggregate use of the shared resource by other users in the plurality of users.

13. A machine-readable storage medium encoded with instructions executable by a processor for allocating cost of a shared resource, the machine-readable storage medium comprising:
instructions to determine a monetary cost, for a period of time, of the shared resource;
instructions to determine a distribution, between a plurality of users, of usage of the shared resource during the period of time, wherein the plurality of users are associated with communications to and from the shared resource during the period of time; and
instructions to generate a representation of usage, of the shared resource, by one of the plurality of users during the period of time, wherein the generated representation indicates usage by the one of the plurality of users compared to total usage by the plurality of users during the period of time.

14. The machine-readable storage medium of claim 13, wherein the distribution is determined based on data collected using real user monitoring (RUM) technology.

15. The machine-readable storage medium of claim 13, wherein the one of the plurality of users is a first user, the machine-readable storage medium further comprising instructions to generate an aggregate representation of usage, of the shared resource, by users other than the first user in the plurality of users during the period of time, wherein relative sizes of the first user representation and the aggregate representation are based on usage of the shared resource by the first user relative to aggregate use of the shared resource by other users in the plurality of users during the period of time.
